(19) United States
(12) Patent Application Publication
(10) Pub. No.: US 2026/0355990 A1
(43) Pub. Date: Nov. 12, 2026

(54) RECIPROCATING CUTTER HEAD

(71) Applicant: Zhejiang Jingbo Hardware Technology Co., Ltd., Lishui (CN)

(72) Inventors: Jianxun FANG, Lishui (CN); Haohao DENG, Lishui (CN); Zhijian JIN, Lishui (CN); Bingjie JIN, Lishui (CN)

(21) Appl. No.: 19/728,617

(22) Filed: Jul. 2, 2026

(30) Foreign Application Priority Data
Nov. 14, 2025 (CN) 202522417047.4

(51) Int. Cl. B26B 19/04; B26B 19/38

(52) U.S. Cl. CPC B26B 19/046; B26B 19/384; B26B 19/3846

(57) ABSTRACT

A reciprocating cutter head includes a moving blade assembly including a T-shaped moving blade base driven by a driving component for reciprocating motion, and a middle blade assembly and a side moving blade assembly stacked on the moving blade base from top to bottom. The middle blade assembly includes a central moving blade corresponding to a skin-contact zone of a main blade surface, and a plurality of floating elastic components configured to elastically support the central moving blade on the moving blade holder. A bilaterally-symmetrical four-corner outwardly-splayed or inwardly-splayed support structure is formed on a bottom of the central moving blade. The middle blade assembly is stackedly mounted above the side moving blade assembly within an accommodating cavity in a non-contact manner through the four-corner outwardly-splayed or inwardly-splayed support structure.

### CROSS-REFERENCE TO RELATED APPLICATIONS

This application claims the benefit of priority from Chinese Patent Application No. 202522417047.4, filed on Nov. 14, 2025. The content of the aforementioned application, including any intervening amendments thereto, is incorporated herein by reference in its entirety.

### TECHNICAL FIELD

This application relates to reciprocating cutter heads for personal cleaning and care, and more particularly to a reciprocating cutter head.

### BACKGROUND

Reciprocating cutters on the market include a stationary foil, a plastic support base, and a moving blade assembly. The stationary foil is formed by bending a thin metal sheet. Owing to a moving blade needs to be in close contact with a lower surface of the stationary foil to achieve cutting, even a cutting edge of the moving blade needs to match a bending curvature of the stationary foil. Besides, when this product is used, uneven force on the stationary foil may cause excessive current, or even blade jamming. Furthermore, after long-term use, the stationary foil may deform, affecting cutting efficiency and causing beard hair pulling or tugging. For the stationary foil made of bent thin metal, a spring element is added to a stationary blade assembly, which is a stationary blade support, to avoid a rigid fit problem. However, such structure only allows the entire foil to have a certain degree of floating, which is only applicable to a single moving blade. For an irregularly shaped stationary foil, especially a non-conventional n-shaped stationary blade with partitioned hair-receiving slots, the single moving blade cannot meet the cutting requirements. In a reciprocating cutter head, a multi-moving-blade structure generally employs a plurality of moving blade units arranged in parallel to correspond to the partitions, which requires a large accommodating cavity for accommodating a cutter head with large volume, and multiple components.

### SUMMARY

In view of the defects in the prior art, the present disclosure is to provide a reciprocating cutter head having two moving blade assemblies stacked up and down without interfering with each other, which has compact internal structure and requires little space.

In order to achieve the above objectives, the present disclosure adopts the following technical solutions.

A reciprocating cutter head is provided, comprising:
a blade frame;
an outer foil; and
a moving blade assembly;
wherein the outer foil is connected to the blade frame; the moving blade assembly is in movable contact with a lower surface of the outer foil such that the moving blade assembly is movable relative to the outer foil;
the blade frame and the outer foil are configured to enclose an accommodating cavity, and the moving blade assembly is mounted in the accommodating cavity;
the outer foil is integrally formed and has a curved cross-section; the outer foil has a main blade surface having an arc-shaped cross-section in a length direction, and two inclined lateral blade surfaces formed by bending inward and downward respectively from two long edges of the main blade surface; the main blade surface is provided with a first skin-contact groove zone, and the two inclined lateral blade surfaces are each provided with a second skin-contact groove zone; and the first skin-contact groove zone and the second skin-contact groove zone are each provided with a plurality of hair-receiving grooves;
the moving blade assembly comprises a moving blade holder in a substantially T shape, a middle blade assembly and a side moving blade assembly; the moving blade holder is configured to be driven by a driving component for reciprocating motion; the middle blade assembly and the side moving blade assembly are sequentially stacked on the moving blade holder from top to bottom; the middle blade assembly is configured to cooperate with the first skin-contact groove zone to achieve hair cutting; and the side moving blade assembly is configured to cooperate with the second skin-contact groove zone to achieve hair cutting; and
the middle blade assembly comprises a central moving blade corresponding to the first skin-contact groove zone, and a plurality of first floating elastic components configured to elastically support the central moving blade on the moving blade holder; a lower portion of each of the plurality of first floating elastic components is configured to pass through the side moving blade assembly to abut against the moving blade holder, so as to form a bilaterally symmetrical four-corner outwardly-splayed or inwardly-splayed support structure on a bottom of the central moving blade; the middle blade assembly is stackedly mounted above the side moving blade assembly in a non-contact manner within the accommodating cavity through the bilaterally symmetrical four-corner outwardly-splayed or inwardly-splayed support structure.

In an embodiment, a middle portion of the middle blade assembly is provided with a first lateral positioning structure; lateral ends of the sides moving blade assembly are each provided with a second lateral positioning structure; and the first lateral positioning structure and the second lateral positioning structure are configured to cooperate with the moving blade holder for laterally positioning the central moving blade and the side moving blade;
the first lateral positioning structure comprises a rail groove at a middle of the moving blade holder, and a first support guide handle extending downward from a middle of a bottom of the central moving blade; the rail groove is configured to longitudinally extend; the first support guide handle is inserted into the rail groove, and is configured to slide up and down within the rail groove; and
the second lateral positioning structure is a snap-groove structure comprising a 7-shaped hook structure and an inward-recessed groove; the 7-shaped hook structure comprises a longitudinal rib and a free hook portion; the inward-recessed groove is configured to be in vertical movable fit with the longitudinal rib; and the free hook portion is configured to limit the inward-recessed groove to prevent the inward-recessed groove from being released.

In an embodiment, the central moving blade is integrally formed, and comprises an elongated blade surface and a second support guide handle; the elongated blade surface extends in a reciprocating direction, and is corresponding to the first skin-contact groove zone; and
the second support guide handle is configured to extend downward from a middle portion of two lateral side edges of the elongated blade surface, and is configured to cooperate with the rail groove.

In an embodiment, two connection portions are respectively provided at the two lateral side edges of the elongated blade surface; the two connection portions are symmetrically located at transverse sides of the second support guide handle, respectively; the two connection portions are adapted to an upper portion of each of the plurality of first floating elastic components; and
the two connection portions are configured to fix the plurality of first floating elastic components at four corners of a lower bottom of the elongated blade surface, and are configured to elastically support the plurality of first floating elastic components on the moving blade holder in an outwardly-splayed or inwardly-splayed configuration.

In an embodiment, each of the plurality of first floating elastic components comprises an upper horizontal portion, a bent deformation portion and a lower abutment portion; the upper horizontal portion has a horizontal sheet shape, and is configured to be fittingly fixed cooperate with the two connection portions; the bent deformation portion is configured to extend inclinedly downward and outward from an end of the upper horizontal portion; and the lower abutment portion abuts against the moving blade holder, and a free end of the lower abutment portion is configured to be tilted upwardly and outwardly.

In an embodiment, the moving blade holder comprises a base in an elongated shape and a transmission head; and the transmission head is integrally formed at a lower portion of the base; and
the base is provided with an outwardly-curved boss corresponding to the four-corner outwardly-splayed or inwardly-splayed support structure; the outwardly-curved boss is configured to expand outward from transverse edges of the base to guide and limit a lower portion of each of the plurality of first floating elastic components, so as to enable the four-corner outwardly-splayed or inwardly-splayed support structure to achieve surface-balanced support for the central moving blade.

In an embodiment, the side moving blade assembly comprises a side moving blade and a second floating elastic component; the side moving blade is mounted within the accommodating cavity below the central moving blade, and is corresponding to the second skin-contact groove zone; the second floating elastic component is fixedly mounted on the base of the moving blade holder; lateral sides of the second floating elastic component are respectively provided with a plurality of elastic legs to abut against a bottom surface of the side moving blade, so as to achieve fit between the side moving blade and the second skin-contact groove zone; and
the side moving blade comprises a connecting body extending in the reciprocating direction and a side blade portion, wherein the connecting body is configured to be adapted and connected to the accommodating cavity; the side blade portion is configured to extend outwardly from two lateral side edges of the connecting body, and to fit the second skin-contact groove zone; and the connecting body is provided with a plurality of through holes configured to allow the plurality of first floating elastic components to pass through to abut against the base of the moving blade holder.

In an embodiment, a middle portion of the side moving blade assembly is provided with a first lateral positioning structure; lateral ends of the middle blade assembly are each provided with a second lateral positioning structure; and the first lateral positioning structure and the second lateral positioning structure are configured to cooperate with the moving blade holder for laterally positioning the side moving blade assembly and the middle blade assembly;
the first lateral positioning structure comprises a rail groove extending longitudinally at a middle of the moving blade holder, and a support slide handle extending downward from a middle of a bottom of the side moving blade assembly; the support slide handle is inserted into the rail groove, and is configured to slide up and down within the rail groove; and
the second lateral positioning structure is a snap-groove structure comprising a 7-shaped hook structure and an inward-recessed groove; the 7-shaped hook structure comprises a longitudinal rib and a free hook portion; the inward-recessed groove is configured to be in vertical movable fit with the longitudinal rib; and the free hook portion is configured to limit the inward-recessed groove to prevent the inward-recessed groove from being released.

The present disclosure has the following beneficial effects. The present disclosure adopts vertically stacked dual moving blade assemblies, which achieves high space utilization, significantly reduces an overall size of cutter heads, and is suitable for an irregular stationary foil, especially non-conventional n-shaped stationary meshes with partitioned hair-receiving grooves for both long and short beard hair. The vertically stacked dual moving blade assemblies are arranged in a non-contact manner, ensuring they do not interfere with each other and operate independently. The middle blade assembly is provided with the four-corner outwardly-splayed or inwardly-splayed support structure, the middle blade assembly and the side moving blade assembly are mounted within the cutter head without contacting through the four-corner outwardly-splayed or inwardly-splayed support structure. The four-corner outwardly-splayed or inwardly-splayed support structure also provides vertical floating capability for the central moving blade, allowing the central moving blade to adaptively and tightly conform to the main blade surface, thereby improving cutting efficiency and avoiding beard tugging. The cutter head features a smooth surface without sharp edges or burrs. A hair inlet can be set up in a large area with strong integrity, which greatly reduces a risk of skin cuts, provides a better skin feel, and is easy to manufacture. The reciprocating cutter head in the present disclosure can be assembled without screws, and can even be connected without glue or threads, making it environmentally friendly while ensuring a stable connection with clear, compact, and rational internal structure.

The present disclosure will be described in detail below with reference to the accompanying drawings to make objectives, technical solutions, and advantages of the present disclosure clearer.

### BRIEF DESCRIPTION OF THE DRAWINGS

FIG. 1 is a structural diagram of a reciprocating cutter head according to an embodiment of the present disclosure.

FIG. 2 is an explosive view of the reciprocating cutter head in FIG. 1.

FIG. 3 is a structural diagram of a moving blade assembly according to an embodiment of the present disclosure.

FIG. 4 is a structural diagram of a middle blade assembly according to an embodiment of the present disclosure.

FIG. 5 is a structural diagram of a four-corner outwardly-splayed or inwardly-splayed support structure according to an embodiment of the present disclosure.

### DETAILED DESCRIPTION OF EMBODIMENTS

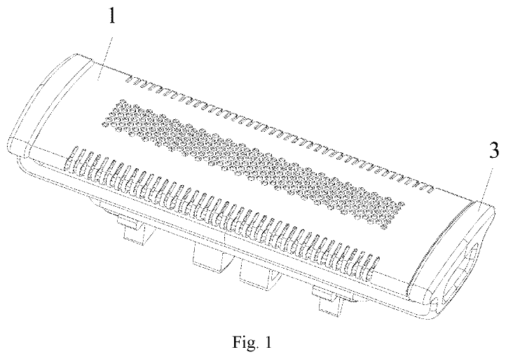

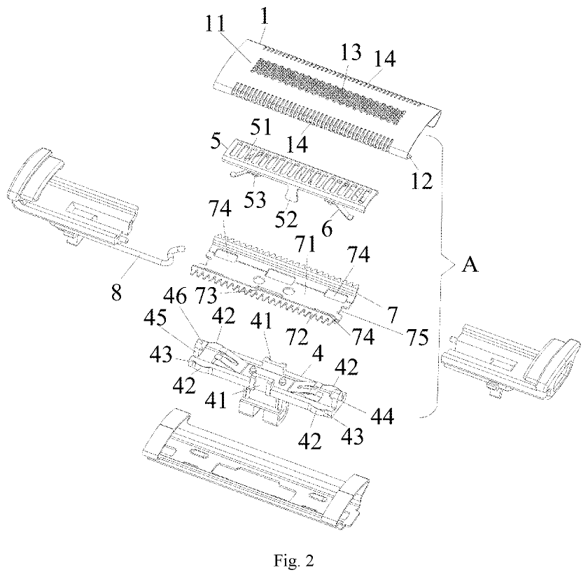

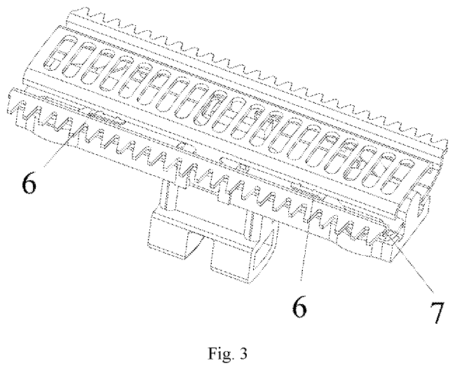

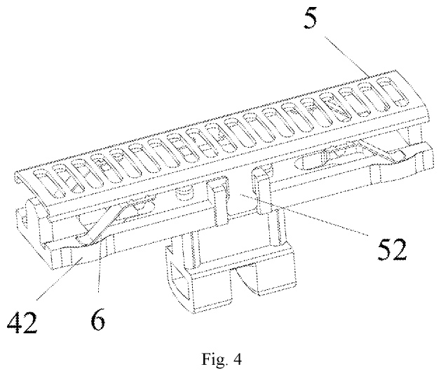

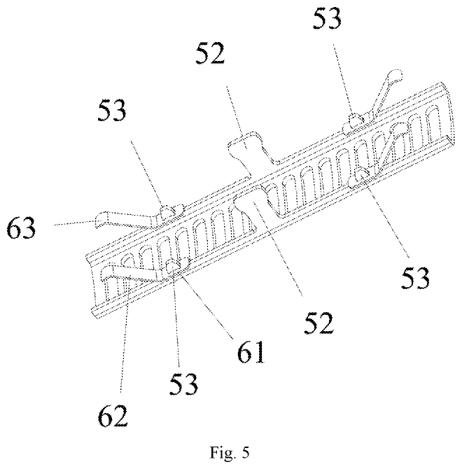

FIGS. 1-5 show an embodiment of a reciprocating cutter head of the present disclosure. The reciprocating cutter head includes a blade frame 3, an outer foil 1 and a moving blade assembly A, where the outer foil 1 is connected to the blade frame 3, and is integrally formed by a flexible metal sheet, and the moving blade assembly A is in movable contact with a lower surface of the outer foil 1 such that the moving blade assembly is movable relative to the outer foil. The blade frame and the outer foil are configured to enclose an accommodating cavity, and the moving blade assembly is mounted in the accommodating cavity. The reciprocating cutter head in this embodiment is hammer-shaped. The outer foil 1 is integrally formed, and has a curved cross-section, that is, the outer foil has a main blade surface 11 having an arc-shaped cross-section in a length direction, and two inclined lateral blade surfaces 12 formed by bending inward and downward respectively from two long edges of the main blade surface 11. The main blade surface 11 and the two inclined lateral blade surfaces 12 are connected by arc-shaped transitions. The main blade surface is provided with a first skin-contact groove zone 13, and the two inclined lateral blade surfaces are each provided with a second skin-contact groove zone 14. The first skin-contact groove zone and the second skin-contact groove zone are each provided with a plurality of hair-receiving grooves. The first skin-contact groove zone 13 is provided on a middle portion of the main blade surface. The second skin-contact groove zone 14 is configured to extend from a connection position between the two inclined lateral blade surfaces and the main blade surface. Or as shown in this embodiment, the second skin-contact groove zone 14 is configured to extend from positions on longitudinal sides of the main blade surface 11 away from the first skin-contact groove zone toward the two inclined lateral blade surfaces. The moving blade assembly includes a moving blade holder 4 in a substantially T shape, a middle blade assembly and a side moving blade assembly is configured to be driven by a driving component for reciprocating motion. The middle blade assembly and the side moving blade assembly are sequentially stacked on the moving blade holder 4 from top to bottom. Compared to the parallel arrangement of units in the prior art, the stacked mounting adopted in this embodiment has no redundant components, requires a smaller volume, and features a compact and clear internal structure. The middle blade assembly and the first skin-contact groove zone are configured to correspondingly cooperate to achieve hair cutting. The two inclined lateral blade surfaces and the second skin-contact groove zone are configured to correspondingly cooperate to achieve hair cutting. The middle blade assembly includes a central moving blade 5 corresponding to the first skin-contact groove zone, and four first floating elastic components 6 configured to elastically support the central moving blade on the moving blade holder 4. A lower portion of each of the four first floating elastic components 6 is configured to pass through the side moving blade assembly to abut against the moving blade holder 4, so as to form a bilaterally symmetrical four-corner outwardly-splayed or inwardly-splayed support structure on a bottom of the central moving blade. The middle blade assembly is stackedly mounted above the side moving blade assembly in a non-contact manner within the accommodating cavity through the bilaterally symmetrical four-corner outwardly-splayed or inwardly-splayed support structure. In this embodiment, the bilaterally symmetrical four-corner outwardly-splayed support structure is provided. To obtain the bilaterally symmetrical four-corner inwardly-splayed support structure, only the four first floating elastic components 6 in this embodiment is needed to be reversed, since the principle remains the same, further description is omitted.

The middle blade assembly and the side moving blade assembly are arranged on the moving blade holder. The moving blade holder is configured to drive the middle blade assembly and the side moving blade assembly to perform left-and-right reciprocating motion. In order to achieve non-contact stacking while ensuring lateral positioning of the middle blade assembly and the side moving blade assembly on the moving blade holder, the middle blade assembly and the side moving blade assembly in this embodiment achieve lateral positioning and vertically guided floating at the central position at end side positions, respectively. That is, a middle portion of the middle blade assembly is provided with a first lateral positioning structure. Lateral ends of the side moving blade assembly are each provided with a second lateral positioning structure, and the first lateral positioning structure and the second lateral positioning structure are configured to cooperate with the moving blade holder for laterally positioning the middle moving blade and the side moving blade. The first lateral positioning structure includes a rail groove 41 at a middle of the moving blade holder, and a first support guide handle 52 extending downward from a middle of a lower bottom of the central moving blade 5. The rail groove is configured to longitudinally extend. The first support guide handle 52 is inserted into the rail groove, and is configured to slide up and down within the rail groove. A free end of the first support guide handle 52 has an enlarged head structure, so that the first support guide handle 52 can slide smoother within the rail groove, which reduces friction, assisting in front-and-rear lateral positioning, and preventing front-and-rear wobbling and twisting. In this embodiment, the central moving blade 5 is integrally formed, and includes an elongated blade surface and two second support guide handles. The elongated blade surface extends in a reciprocating direction, and is corresponding to the first skin-contact groove zone. The two second support guide handle are configured to extend downward from a middle part of two lateral side edges of the elongated blade surface, and are configured to cooperate with two rail grooves. The two second support guide handles are arranged in parallel in a front-and-rear direction, and corresponding the two rail grooves are respectively provided at middle positions of front and rear side walls of the moving blade holder. Two connection portions 53 are respectively provided at the two transverse side edges of the elongated blade surface. The two connection portions are symmetrically located at transverse sides of the second support guide handle, respectively. The two connection portion 53 are adapted to an upper portion of each of the four first floating elastic components. The two connection portions 53 are configured to fix the four first floating elastic components at four corners of a lower bottom of the elongated blade surface 51, and are configured to elastically support the four first floating elastic components on the moving blade holder in an outwardly-splayed configuration. The second lateral positioning structure is a snap-groove structure including a 7-shaped hook structure 44 and an inward-recessed groove 75. The 7-shaped hook structure comprises a longitudinal rib 45 and a free hook portion. The inward-recessed groove 75 is configured to be in vertical movable fit with the longitudinal rib 45. The free hook portion 46 is configured to limit the inward-recessed groove to prevent the inward-recessed groove from being released.

In an embodiment, arrangement of the lateral positioning structures may be swapped. A middle portion of the side moving blade assembly is provided with a first lateral positioning structure. Lateral ends of the middle blade assembly are each provided with a second lateral positioning structure. The first lateral positioning structure and the second lateral positioning structure are configured to cooperate with the moving blade holder for laterally positioning the side moving blade assembly and the middle blade assembly. The first lateral positioning structure includes a rail groove extending longitudinally at a middle of the moving blade holder, and a support slide handle extending downward from a middle of a bottom of the side moving blade assembly. The support slide handle is inserted into the rail groove, and is configured to slide up and down within the rail groove. The second lateral positioning structure is a snap-groove structure comprising a 7-shaped hook structure and an inward-recessed groove. The 7-shaped hook structure comprises a longitudinal rib and a free hook portion; the inward-recessed groove is configured to be in vertical movable fit with the longitudinal rib. The free hook portion is configured to limit the inward-recessed groove to prevent the inward-recessed groove from being released.

Each of the four first floating elastic components includes an upper horizontal portion 61, a bent deformation portion 62 and a lower abutment portion 63. The upper horizontal portion 61 has a horizontal sheet shape, and is configured to be fittingly fixed with the two connection portions. The bent deformation portion 62 is configured to extend inclinedly downward and outward from an end of the upper horizontal portion 61. The lower abutment portion 63 abuts against the moving blade holder, and a free end of the lower abutment portion 63 is configured to be tilted upwardly and outwardly. When the lower abutment portion 63 under pressure, an angle between the upper horizontal portion 61 and the bent deformation portion 62 is an obtuse angle, particularly, is an angle of 105° to 168°, each of the four first floating elastic components balances upper pressure-bearing capacity with lower damping and limiting capability. In order to enhance stability and surface balance of the four-corner outwardly-splayed support structure formed by the four first floating elastic components, this embodiment adds a guiding limit baffle for the lower abutment portion 63 on a base based on lower friction force limit. In an embodiment, the moving blade holder includes the base in an elongated shape and a transmission head. The transmission head is integrally formed at a lower portion of the base. The base is provided with an outwardly-curved boss 42 corresponding to the four-corner outwardly-splayed structure. The outwardly-curved boss is configured to expand outward from transverse edges of the base to guide and limit a lower portion of each of the four first floating elastic components, so as to enable the four-corner outwardly-splayed or inwardly-splayed support structure to achieve surface-balanced support for the central moving blade. An arc-shaped flange 43 is formed by protruding along an outer arc edge on the outwardly-curved boss. An outer side of the lower abutment portion 63 abuts against the arc-shaped flange 43, which not only increases damping of the lower abutment portion but also provides guidance for movement of the lower abutment portion 63. Furthermore, four outwardly-curved bosses 42 are fixed in position, and the four-corner outwardly-splayed support structure, with its four legs respectively acting on the four outwardly-curved bosses 42, has stronger self-centering capability, ensuring that a center of the four-corner outwardly-splayed support structure is always on a central axis of the moving blade holder 4. That is, through guiding limitation of the four outwardly-curved bosses 42, the four-corner outwardly-splayed support structure achieves surface-balanced support for the central moving blade 5.

The side moving blade assembly includes a side moving blade 7 and a second floating elastic component 8. The side moving blade 7 is mounted within the accommodating cavity below the central moving blade, and is corresponding to the second skin-contact groove zone. The second floating elastic component 8 is fixedly mounted on the base of the moving blade holder 4. Lateral sides of the second floating elastic component 8 are respectively provided with a plurality of elastic legs to abut against a bottom surface of the side moving blade, so as to achieve fit between the side moving blade and the second skin-contact groove zone. The side moving blade 7 includes a connecting body 71 extending in the reciprocating direction and a side blade portion 72, where the connecting body 71 is configured to be adapted and connected to the accommodating cavity. The side blade portion 72 is configured to extend outwardly from two lateral side edges of the connecting body, and to fit the second skin-contact groove zone. The connecting body 71 is provided with a plurality of first through holes 73 configured to allow the second support guide handle to pass therethrough to cooperate with the rail groove, and a second through hole 74 allowing the plurality of first floating elastic components to pass therethrough to abut against the base 4. The second through hole is an elongated through hole, so that its length is sufficient to avoid interfering with deformation of the bent deformation portion 62.

The middle blade assembly and the side moving blade assembly each have vertical floating capability, allowing the middle blade assembly and the side moving blade assembly to adaptively and tightly conform to corresponding skin-contact zones, thereby improving cutting efficiency and avoiding beard tugging and beard missing.

In this embodiment, the outer foil 1 is fixedly mounted on the blade frame via a blade support to ensure its integrity. The blade frame is formed by fixedly connecting two connecting units from transverse sides. Locking of a split-type blade frame after assembly can be achieved by an interference plug-in connection or a snap-fit structure. To further enhance post-assembly stability, this embodiment additionally provides a tightening component 8. The tightening component 8 is mounted on the blade frame in a fully or partially enclosed manner, that is, the tightening component 8 at least partially encloses two connecting units from left and right in a transverse direction. After the two connecting units are inserted from the transverse sides of the outer foil 1 equipped with the blade support and are connected to form the blade frame, the tightening component locks the two connecting units. The tightening component 8 can be a bar spring. In this embodiment, such bar spring is shown for illustrating, and it can be embedded in a concealed manner for aesthetic purposes.

A stationary foil on the reciprocating cutter head of the present disclosure i not prone to deformation as a whole. A thickness of the stationary foil can be reduced to below 10 microns, or even to 4 to 5 microns, achieving an ultra-thinness that cannot be realized by other process structures. In this way, the present disclosure not only provides higher sharpness of the cutter head and cleaner hair cutting, but also ensures sufficient support strength for longer service life, thereby guaranteeing the cutting sharpness and safety of the reciprocating cutter head.

Disclosed above are only specific embodiments of the present disclosure, rather than limiting the disclosure. Any modifications and improvements made by those of ordinary skill in the art without departing from the spirit of the present disclosure, shall fall within the scope of this application defined by the appended claims.

What is claimed is:

1. A reciprocating cutter head, comprising:
a blade frame;
an outer foil; and
a moving blade assembly;
wherein the outer foil is connected to the blade frame; the moving blade assembly is in movable contact with a lower surface of the outer foil such that the moving blade assembly is movable relative to the outer foil;
the blade frame and the outer foil are configured to enclose an accommodating cavity, and the moving blade assembly is mounted in the accommodating cavity;
the outer foil is integrally formed, and has a curved cross-section; the outer foil has a main blade surface having an arc-shaped cross-section in a length direction, and two inclined lateral blade surfaces formed by bending inward and downward respectively from two long edges of the main blade surface; the main blade surface is provided with a first skin-contact groove zone, and the two inclined lateral blade surfaces are each provided with a second skin-contact groove zone; and the first skin-contact groove zone and the second skin-contact groove zone are each provided with a plurality of hair-receiving grooves;
the moving blade assembly comprises a moving blade holder in a substantially T shape, a middle blade assembly and a side moving blade assembly; the moving blade holder is configured to be driven by a driving component for reciprocating motion; the middle blade assembly and the side moving blade assembly are sequentially stacked on the moving blade holder from top to bottom; the middle blade assembly is configured to cooperate with the first skin-contact groove zone to achieve hair cutting; and the side moving blade assembly is configured to cooperate with the second skin-contact groove zone to achieve hair cutting; and
the middle blade assembly comprises a central moving blade corresponding to the first skin-contact groove zone, and a plurality of first floating elastic components configured to elastically support the central moving blade on the moving blade holder; a lower portion of each of the plurality of first floating elastic components is configured to pass through the side moving blade assembly to abut against the moving blade holder, so as to form a bilaterally symmetrical four-corner outwardly-splayed or inwardly-splayed support structure on a bottom of the central moving blade; the middle blade assembly is stackedly mounted above the side moving blade assembly in a non-contact manner within the accommodating cavity through the bilaterally symmetrical four-corner outwardly-splayed or inwardly-splayed support structure.

2. The reciprocating cutter head of claim 1, wherein a middle portion of the middle blade assembly is provided with a first lateral positioning structure; lateral ends of the side moving blade assembly are each provided with a second lateral positioning structure; and the first lateral positioning structure and the second lateral positioning structure are configured to cooperate with the moving blade holder for laterally positioning the central moving blade and the side moving blade;
the first lateral positioning structure comprises a rail groove at a middle of the moving blade holder, and a first support guide handle extending downward from a middle of a bottom of the central moving blade; the rail groove is configured to longitudinally extend; the first support guide handle is inserted into the rail groove, and is configured to slide up and down within the rail groove; and
the second lateral positioning structure is a snap-groove structure comprising a 7-shaped hook structure and an inward-recessed groove; the 7-shaped hook structure comprises a longitudinal rib and a free hook portion; the inward-recessed groove is configured to be in vertical movable fit with the longitudinal rib; and the free hook portion is configured to limit the inward-recessed groove to prevent the inward-recessed groove from being released.

3. The reciprocating cutter head of claim 2, wherein the central moving blade is integrally formed, and comprises an elongated blade surface and a second support guide handle; the elongated blade surface extends in a reciprocating direction, and is corresponding to the first skin-contact groove zone; and
the second support guide handle is configured to extend downward from a middle portion of two lateral side edges of the elongated blade surface, and is configured to cooperate with the rail groove.

4. The reciprocating cutter head of claim 3, wherein two connection portions are respectively provided at the two lateral side edges of the elongated blade surface; the two connection portions are symmetrically located at transverse sides of the second support guide handle, respectively; the two connection portions are adapted to an upper portion of each of the plurality of first floating elastic components; and
the two connection portions are configured to fix the plurality of first floating elastic components at four corners of a lower bottom of the elongated blade surface, and are configured to elastically support the plurality of first floating elastic components on the moving blade holder in an outwardly-splayed or inwardly-splayed configuration.

5. The reciprocating cutter head of claim 4, wherein each of the plurality of first floating elastic components comprises an upper horizontal portion, a bent deformation portion and a lower abutment portion; the upper horizontal portion has a horizontal sheet shape, and is configured to be fittingly fixed with the two connection portions; the bent deformation portion is configured to extend inclinedly downward and outward from an end of the upper horizontal portion;
and the lower abutment portion abuts against the moving blade holder, and a free end of the lower abutment portion is configured to be tilted upwardly and outwardly.

6. The reciprocating cutter head of claim 1, wherein the moving blade holder comprises a base in an elongated shape and a transmission head; and the transmission head is integrally formed at a lower portion of the base; and
the base is provided with an outwardly-curved boss corresponding to the four-corner outwardly-splayed or inwardly-splayed support structure; the outwardly-curved boss is configured to expand outward from transverse edges of the base to guide and limit a lower portion of each of the plurality of first floating elastic components, so as to enable the four-corner outwardly-splayed or inwardly-splayed support structure to achieve surface-balanced support for the central moving blade.

7. The reciprocating cutter head of claim 2, wherein the moving blade holder comprises a base in an elongated shape and a transmission head; and the transmission head is integrally formed at a lower portion of the base; and
the base is provided with an outwardly-curved boss corresponding to the four-corner outwardly-splayed or inwardly-splayed support structure; the outwardly-curved boss is configured to expand outward from transverse edges of the base to guide and limit a lower portion of each of the plurality of first floating elastic components, so as to enable the four-corner outwardly-splayed or inwardly-splayed support structure to achieve surface-balanced support for the central moving blade.

8. The reciprocating cutter head of claim 3, wherein the moving blade holder comprises a base in an elongated shape and a transmission head; and the transmission head is integrally formed at a lower portion of the base; and
the base is provided with an outwardly-curved boss corresponding to the four-corner outwardly-splayed or inwardly-splayed support structure; the outwardly-curved boss is configured to expand outward from transverse edges of the base to guide and limit a lower portion of each of the plurality of first floating elastic components, so as to enable the four-corner outwardly-splayed or inwardly-splayed support structure to achieve surface-balanced support for the central moving blade.

9. The reciprocating cutter head of claim 4, wherein the moving blade holder comprises a base in an elongated shape and a transmission head; and the transmission head is integrally formed at a lower portion of the base; and
the base is provided with an outwardly-curved boss corresponding to the four-corner outwardly-splayed or inwardly-splayed support structure; the outwardly-curved boss is configured to expand outward from transverse edges of the base to guide and limit a lower portion of each of the plurality of first floating elastic components, so as to enable the four-corner outwardly-splayed or inwardly-splayed support structure to achieve surface-balanced support for the central moving blade.

10. The reciprocating cutter head of claim 5, wherein the moving blade holder comprises a base in an elongated shape and a transmission head; and the transmission head is integrally formed at a lower portion of the base; and
the base is provided with an outwardly-curved boss corresponding to the four-corner outwardly-splayed or inwardly-splayed support structure; the outwardly-curved boss is configured to expand outward from transverse edges of the base to guide and limit a lower portion of each of the plurality of first floating elastic components, so as to enable the four-corner outwardly-splayed or inwardly-splayed support structure to achieve surface-balanced support for the central moving blade.

11. The reciprocating cutter head of claim 1, wherein the side moving blade assembly comprises a side moving blade and a second floating elastic component;
the side moving blade is mounted within the accommodating cavity below the central moving blade, and is corresponding to the second skin-contact groove zone;
the second floating elastic component is fixedly mounted on a base of the moving blade holder; lateral sides of the second floating elastic component are respectively provided with a plurality of elastic legs to abut against a bottom surface of the side moving blade, so as to achieve fit between the side moving blade and the second skin-contact groove zone; and
the side moving blade comprises a connecting body extending in the reciprocating direction and a side blade portion, wherein the connecting body is configured to be adapted and connected to the accommodating cavity; the side blade portion is configured to extend outwardly from two lateral side edges of the connecting body, and to fit the second skin-contact groove zone; and the connecting body is provided with a plurality of through holes configured to allow the plurality of first floating elastic components to pass through to abut against the base of the moving blade holder.

12. The reciprocating cutter head of claim 2, wherein the side moving blade assembly comprises a side moving blade and a second floating elastic component; the side moving blade is mounted within the accommodating cavity below the central moving blade, and is corresponding to the second skin-contact groove zone; the second floating elastic component is fixedly mounted on a base of the moving blade holder; lateral sides of the second floating elastic component are respectively provided with a plurality of elastic legs to abut against a bottom surface of the side moving blade, so as to achieve fit between the side moving blade and the second skin-contact groove zone; and
the side moving blade comprises a connecting body extending in the reciprocating direction and a side blade portion, wherein the connecting body is configured to be adapted and connected to the accommodating cavity; the side blade portion is configured to extend outwardly from two lateral side edges of the connecting body, and to fit the second skin-contact groove zone; and the connecting body is provided with a plurality of through holes configured to allow the plurality of first floating elastic components to pass through to abut against the base of the moving blade holder.

13. The reciprocating cutter head of claim 3, wherein the side moving blade assembly comprises a side moving blade and a second floating elastic component; the side moving blade is mounted within the accommodating cavity below the central moving blade, and is corresponding to the second skin-contact groove zone; the second floating elastic component is fixedly mounted on a base of the moving blade holder; lateral sides of the second floating elastic component are respectively provided with a plurality of elastic legs to abut against a bottom surface of the side moving blade, so as to achieve fit between the side moving blade and the second skin-contact groove zone; and
the side moving blade comprises a connecting body extending in the reciprocating direction and a side blade portion, wherein the connecting body is configured to be adapted and connected to the accommodating cavity; the side blade portion is configured to extend outwardly from two lateral side edges of the connecting body, and to fit the second skin-contact groove zone; and the connecting body is provided with a plurality of through holes configured to allow the plurality of first floating elastic components to pass through to abut against the base of the moving blade holder.

14. The reciprocating cutter head of claim 4, wherein the side moving blade assembly comprises a side moving blade and a second floating elastic component; the side moving blade is mounted within the accommodating cavity below the central moving blade, and is corresponding to the second skin-contact groove zone; the second floating elastic component is fixedly mounted on a base of the moving blade holder; lateral sides of the second floating elastic component are respectively provided with a plurality of elastic legs to abut against a bottom surface of the side moving blade, so as to achieve fit between the side moving blade and the second skin-contact groove zone; and
the side moving blade comprises a connecting body extending in the reciprocating direction and a side blade portion, wherein the connecting body is configured to be adapted and connected to the accommodating cavity; the side blade portion is configured to extend outwardly from two lateral side edges of the connecting body, and to fit the second skin-contact groove zone; and the connecting body is provided with a plurality of through holes configured to allow the plurality of first floating elastic components to pass through to abut against the base of the moving blade holder.

15. The reciprocating cutter head of claim 5, wherein the side moving blade assembly comprises a side moving blade and a second floating elastic component; the side moving blade is mounted within the accommodating cavity below the central moving blade, and is corresponding to the second skin-contact groove zone; the second floating elastic component is fixedly mounted on a base of the moving blade holder; lateral sides of the second floating elastic component are respectively provided with a plurality of elastic legs to abut against a bottom surface of the side moving blade, so as to achieve fit between the side moving blade and the second skin-contact groove zone; and
the side moving blade comprises a connecting body extending in the reciprocating direction and a side blade portion, wherein the connecting body is configured to be adapted and connected to the accommodating cavity; the side blade portion is configured to extend outwardly from two lateral side edges of the connecting body, and to fit the second skin-contact groove zone; and the connecting body is provided with a plurality of through holes configured to allow the plurality of first floating elastic components to pass through to abut against the base of the moving blade holder.

16. The reciprocating cutter head of claim 6, wherein the side moving blade assembly comprises a side moving blade and a second floating elastic component; the side moving blade is mounted within the accommodating cavity below the central moving blade, and is corresponding to the second skin-contact groove zone; the second floating elastic component is fixedly mounted on the base of the moving blade holder; lateral sides of the second floating elastic component are respectively provided with a plurality of elastic legs to abut against a bottom surface of the side moving blade, so as to achieve fit between the side moving blade and the second skin-contact groove zone; and
the side moving blade comprises a connecting body extending in the reciprocating direction and a side blade portion, wherein the connecting body is configured to be adapted and connected to the accommodating cavity; the side blade portion is configured to extend outwardly from two lateral side edges of the connecting body, and to fit the second skin-contact groove zone; and the connecting body is provided with a plurality of through holes configured to allow the plurality of first floating elastic components to pass through to abut against the base of the moving blade holder.

17. The reciprocating cutter head of claim 1, wherein a middle portion of the side moving blade assembly is provided with a first lateral positioning structure; lateral ends of the middle blade assembly are each provided with a second lateral positioning structure; and the first lateral positioning structure and the second lateral positioning structure are configured to cooperate with the moving blade holder for laterally positioning the side moving blade assembly and the middle blade assembly;
the first lateral positioning structure comprises a rail groove extending longitudinally at a middle of the moving blade holder, and a support slide handle extending downward from a middle of a bottom of the side moving blade assembly; the support slide handle is inserted into the rail groove, and is configured to slide up and down within the rail groove; and
the second lateral positioning structure is a snap-groove structure comprising a 7-shaped hook structure and an inward-recessed groove; the 7-shaped hook structure comprises a longitudinal rib and a free hook portion; the inward-recessed groove is configured to be in vertical movable fit with the longitudinal rib; and the free hook portion is configured to limit the inward-recessed groove to prevent the inward-recessed groove from being released.
